(19) United States
(12) Patent Application Publication
(10) Pub. No.: US 2025/0037149 A1
(43) Pub. Date: Jan. 30, 2025

(54) APPLICATION OF NFT TECHNOLOGY TO GREEN ENERGY CREDIT COMMODITIES

(71) Applicants: Johnathan Sterling Findlay, Portland, OR (US); Cathleen Eva Corrie, Portland, OR (US)

(72) Inventors: Johnathan Sterling Findlay, Portland, OR (US); Cathleen Eva Corrie, Portland, OR (US)

(21) Appl. No.: 18/786,559

(22) Filed: Jul. 28, 2024

Related U.S. Application Data
(60) Provisional application No. 63/529,647, filed on Jul. 28, 2023.

(51) Int. Cl. G06Q 30/018; G06Q 40/04

(52) U.S. Cl. CPC G06Q 30/018; G06Q 40/04

(57) ABSTRACT

Dual Class Energy Credits are digital commodity tokens that are generated based on the significant net positive production of green energy, as opposed to the consumption of energy as with typical crypto currencies, and the corresponding sale of that Energy. For every X amount of green energy sold to the grid, Y energy credits are produced for the “sponsor” of that source, who can then hold onto those tokens or spend them as currency as with any other crypto currency. The two classes of Commodity are “vested” and “unvested” tokens. Vested tokens are created when a certain amount of energy has been sold which now has an underlying security such as a currency or other secured asset beyond the energy produced. This “vestible” crypto is used to incentivize the reinvestment of resources into green energy.

### CROSS-REFERENCES TO RELATED APPLICATIONS

This application claims the benefit under 35 U.S.C. § 119(e) of U.S. Provisional Application No. 63/529,647 filed Jul. 28, 2023, which is hereby incorporated by reference.

### BACKGROUND OF THE INVENTION

### Field of the Invention

The invention relates to systems and methods for utilizing non-fungible tokens (NFTs), and particularly such systems and methods that enable privatized multiple class energy/water credit to commoditize the demand for green energy and/or water production using crypto currency and NFT technology over a distributed network including cellular and satellite technology to combat climate change while providing sustainable livelihoods in the age of automation through a proprietary free-market structure creating a transactional energy derivative commodity using a market driven variable pay-down integrated marketplace threshold.

### Description of the Prior Art

An NFT is a unit of data stored on a digital ledger (i.e., a blockchain) that certifies a digital asset to be unique and therefore not fungible. NFTs can be used to represent digital items such as photos, videos, audio, etc. Each NFT may represent a different underlying asset and thus have a different value. NFTs are created when blockchains string records of cryptographic hash, a set of characters identifying a set of data, onto previous records therefore creating a chain of identifiable data blocks. This cryptographic transaction process ensures the authentication of each digital file by providing a digital signature that is used to track NFT ownership.

As used in the area of conventional crypto currencies, such as Bitcoin, the generation of NFTs can consume large and fluctuating amounts of electricity, with a current low estimate of $11,000 per coin varying based on the number of active “miners.” One of the problems with conventional crypto is the tendency to fluctuate wildly and upward in value. Current crypto currencies are thus today sometimes considered as being structured as ongoing Ponzi scheme lotteries where everyone needlessly burns energy so one person, “the winner,” can get all the “value” for all those millions of miners having burned energy for ten minutes.

Therefore, there exists a need for a more stable NFT currency linked to real-world assets that encourages investment in green energy and other socially progressive policies.

### SUMMARY OF THE INVENTION

Dual Class Energy Credits are digital commodity tokens that are generated based on the significant net positive production of green energy, as opposed to the consumption of energy as with typical crypto currencies, and the corresponding sale of that Energy. For every X amount of green energy sold to the grid, Y energy credits are produced for the “sponsor” of that source, who can then hold onto those tokens or spend them as currency as with any other crypto currency. The two classes of Commodity are “vested” and “unvested” tokens. Vested tokens are created when a certain amount of energy has been sold which now has an underlying security such as a currency or other secured asset beyond the energy produced. This establishes the “base value” (B) of the currency, e.g. $1.00. This is the currency component of the Green energy crypto-currency. However, in order to leverage the demand for green energy, there will be a second form of non-fungible token (NFT) known as an “Energy Reserve Credit” (ERC) which can only be sold when there is a specific minimum market value on the currency or other specific criteria and context that is tradeable itself. This “vestible” crypto is used to incentivize the reinvestment of resources into green energy.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is a schematic and flow diagram illustrating the creation and distribution of the energy credit (EC) according to teachings of the present invention.

FIG. 2 is a schematic diagram showing classifications of energy credits (EC) and energy reserve credits (ERC) according to teachings of the present invention.

FIG. 3 is a schematic diagram illustrating market control actions responsive to certain EC value range classifications according to teachings of the present invention.

FIG. 4 is a schematic diagram illustrating the “buydown” mechanic according to teachings of the present invention.

FIG. 5 is a schematic diagram illustrating the distributed reporting of energy sales over a secured mesh network according to teachings of the present invention.

FIG. 6 is a schematic diagram illustrating the conversion of energy credits to a transactional commodity according to teachings of the present invention.

FIG. 7 is a schematic diagram illustrating the “carry over” caused by the market buydown of FIG. 4 according to teachings of the present invention.

FIG. 8 is a schematic diagram illustrating the sale mechanics of non-vested energy reserve credits (ERC) according to teachings of the present invention.

### DETAILED DESCRIPTION

Selected list of terms:
NFT: non-fungible tokens
Source: green energy producing infrastructure; most frequently, solar and wind energy production
Sponsor: any individual or institution that invests in energy from an approved Source, similar to a “miner” in the case of crypto currencies such as Bitcoin
EC (Energy Credit) is a NFT that is backed by $1 basis value as well as $1 in green development.
ERC (Energy Reserve Credit) is essentially an EC waiting to be funded by the market system which uses its fee structure to eventually grant an ERC the needed $1.00 security and $1.00 green development to become “vested” without the need of further investment by the sponsor to in fact offset the sponsors' costs, allowing them to recoup their costs faster than the current green investment model.

The difference between the vested and unvested shares is the presence of the underlying currency security.

### 1. Mining of Net Green Crypto

Conventional crypto currencies, such as Bitcoin, consume large and fluctuating amounts of electricity, with a current low estimate of $11,000 per coin, varying based on the number of active “miners.” Net Green Crypto Currency is designed to be created with a small amount of energy and generates surplus energy to be sold to the energy grid at market rates to create the base value (B) of the currency. So, for one example, an energy credit might have a $1.00 security for every unit in circulation, meaning that an energy company at the other end can accept energy credits from their own customers knowing that an energy credit has a specific minimum value with a variable maximum value (as with any crypto currency). The secondary unit class of NFT is the Vestible units that do not yet have security.

These set a mechanism to create an automatic payoff event for “Sponsors” of the green energy asset. This is accomplished by the exchange rate “overheating,” showing demand for green energy production, which pays off green infrastructure by leveraging the difference in market rate between the base value (B) and the Market Value (M) as well as a sizable share of the market and system transaction fees that go towards paying off people's sponsored sources to alleviate their monthly costs while they still get to benefit from the generated energy credits that have been funded by sale to the grid. That means that the difference between B and M equals the free market value of green energy making the total value of an energy credit B+M, the compound positive of production value of green energy plus the market green energy value, versus the value of “Dirty energy dollars.”

The underlying fiat dollar security, the M-Market Value realized whenever the green energy generated by a source is sold for dollars to the energy grid, gives the crypto-currency the traits of a traditional currency, a more traditional commodity, and a traditional crypto currency, as well as a more traditional derivative commodity to maximize free market value and stability where multiple market forces that are traditionally more separated bolster each other to create clear value for a sustainable economy for our changing times.

All the currency would be registered through a central exchange and means of production to ensure the integrity of the creation of green energy. After that, the NFT would function much like a typical crypto currency, if you want to keep some in your pocket, but would also work as its own wallet and card system. From a “Miner” standpoint, in order to start printing your own crypto you would go to the website to “become a sponsor” by signing up to pay, over time, the cost of putting up and maintaining a certain amount of green energy capacity in exchange for the bulk of the Energy Credits produced by the system (with some also going to the land owner, any necessary royalties, local community, and/or government, for supporting the infrastructure at standard rates).

In addition to the rights over the bulk of the vested credits, a new contract also has a certain number of “unvested energy credits” that can only be sold if the market is above a certain value on vested units or other criteria assigned to that account based on context and must be sold through the official exchange which charges in addition to its usual fees an additional $1.00 security for each unit in the conversion off the sale value, where most of the other transaction fees generally are then used to allow for the demand for green energy to pay for the upfront cost of more green energy by paying off the last round of green energy investment early, allowing those investors to become sponsors of the next round of servers or to simply benefit from the revenue created by the fully paid system.

By adding a “re-sponsor” or “auto-renewal” button, a user could have these events and ongoing energy production pay for the purchase of more sponsored assets. Even if the “market value” of the currency never actually reaches the cutoff, a sizable chunk of all fees charged by the organization would go towards paying off people's assets on a first come, first served basis. This means that over time a person could individually, through their own financial investment in the grid through crypto currency, become a green energy net positive individual as a long-term investment strategy. Because once the hardware is paid for, they continue to generate revenue from it; the fees are only for maintenance and can be paid out of the revenue generated, meaning that the market demand for green energy puts that sponsor's asset on residual passive income for living and eventually retirement. Essentially it allows a home to non-localize their personal solar panels if they don't have a roof since they could use the credits to pay their utility bill.

If the market ever crashes, because there is $1.00 security, the value can never completely crater; if the market overheats, unvested reserve units can move onto the market, cooling it off while giving people who funded the last round of infrastructure an early exit to the residual stage years early which can be automatically carried over to a new sponsorship if they have selected the “auto renewal” button or checkbox that immediately orders a new sponsorship to get in line for a buydown faster and their paid progress may carry over in whole or part. Depending on how aggressive activists drive the value of this commodity, it could make a near instantaneous positive feedback loop to justify the creation of green energy infrastructure on an on-demand basis.

The other advantage is that the usage of non-vested units can also be used to prevent upward volatility, channeling it instead towards further green energy growth with each round of infrastructure being built capable of being immediately offset in cost today for demand for green energy tomorrow. As a person continues to “roll over” their sponsorships of green energy assets, they continue those residuals for the lifetime of that hardware, as long as it has surplus after its maintenance fees and insurance has been deducted, while still allowing the market to drive upward showing further demand. With this mechanic, rather than sheer run away value, you get runaway value and runaway green capacity investment through the ERC system. Since maintenance could include some revenue for asset replacement as an option or even requirement “lifetime” could be unlimited. This would allow old infrastructure to be automatically upgraded.

If the inventory of all unvested units is consumed by the market, the organizing entity can produce added energy credits to manage the demand in extreme situations, if a surge of demand overwhelms the first-tier safeguard of the sponsor unvested units. Though with the auto re-sponsor feature this is very unlikely because the fewer auto re-sponsor the faster they get to residuals, so they would just keep getting more capacity to meet the demand due to a shorter line which makes it more appealing, so the line likely simply gets longer.

Working with local governments so that they can benefit from some of the revenue created in their borders will encourage them to accept the currency themselves while encouraging green grid technologies to flourish in their territory. This is to encourage municipalities to welcome the energy production nearby, minimizing energy line loss. Small national governments can have a commodity they can produce themselves that has a stable minimum value, utilizing sponsorship from around the globe to help its grid go green simply by monetizing the demand for the potential of green energy that is not leveraged in traditional economic models, monetizing the engagement to the idea of green energy development as well as the very production of the energy itself. After all, the sooner a green tech pays for itself, the sooner you can make more of it, so if you can leverage that demand in a financially targeted fashion, you can realize rapid progress to a green future.

### 2. Infrastructure

Any energy production technique deemed sufficiently green, can start at centralized points at first but over time become integrated into at-home energy production technologies, once made sufficiently secure to prevent tampering. Partnerships can also be created with companies that create green means of power creation where a portion of the produced energy credits value is shared with the company that created that means in order to make those means more affordable. Further partnerships can be made to split what would normally be the “sponsor” share of the energy credits between the means producer and a homeowner; for example, a homeowner could have a free solar panel to buy affordable power from and the means producer has a rent-free place to put more power production and storage capacity. This decentralized approach can communicate with the central facility reporting the production and sale of the energy to the grid needed to trigger the creation of the crypto currency on a secure server while still allowing the panels or means of production themselves to be where they are best needed.

### 3. Vestible NFTs

Vestible NFTs or “Energy Reserve Credits” allow for the demand of green energy to be monetized by rewarding the sponsor of a new panel with their sponsorship fees. This reward could extend for the duration of the contract being automatically covered by the system once the ERCs reserve price has been met and it has been able to be vested through the market or through transaction fees on a first issued, first sold basis. Most ERCs may or may not in fact start out being held by the Energy Credit Exchange entity that governs the currency depending on strategy.

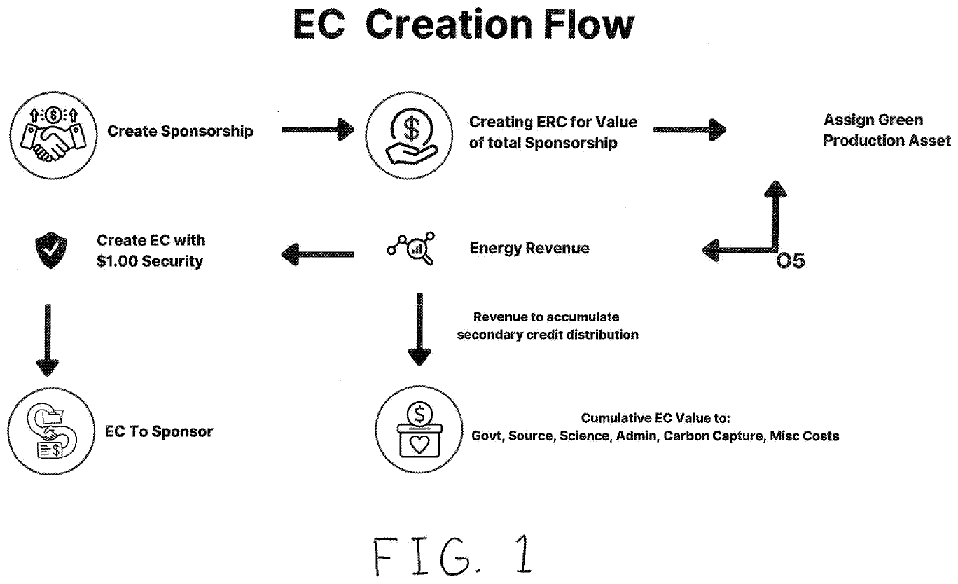

If, and with reference to FIG. 1 for example, a sponsor creates a new contract to sponsor the creation of new production capacity, they agree to pay a monthly fee for a fixed amount of time. However, at the same time the Exchange entity creates an equivalent amount of energy credits to the current total cost of the contract that the sponsor is signing up for, that are in fact un-vested ERCs that can only be sold once the exchange rate for Energy Credits hits a certain level of demand or sold on secondary market once the contract completed if they did not pay off the contract. If the total cost of an EC is $1 at the time the sponsorship contract is created, the total cost of the energy credits are immediately created but cannot be vested until the variable market demand for EC reaches $10, for example, if that is where it is currently set. Once that threshold is reached, all sponsors' qualifying ERCs can be sold; if the sponsor is still in the middle of their contract and is not fully vested, the Exchange entity sells those units and cancels all but possibly maintenance fees if the sponsor does not want them withheld from what is produced.

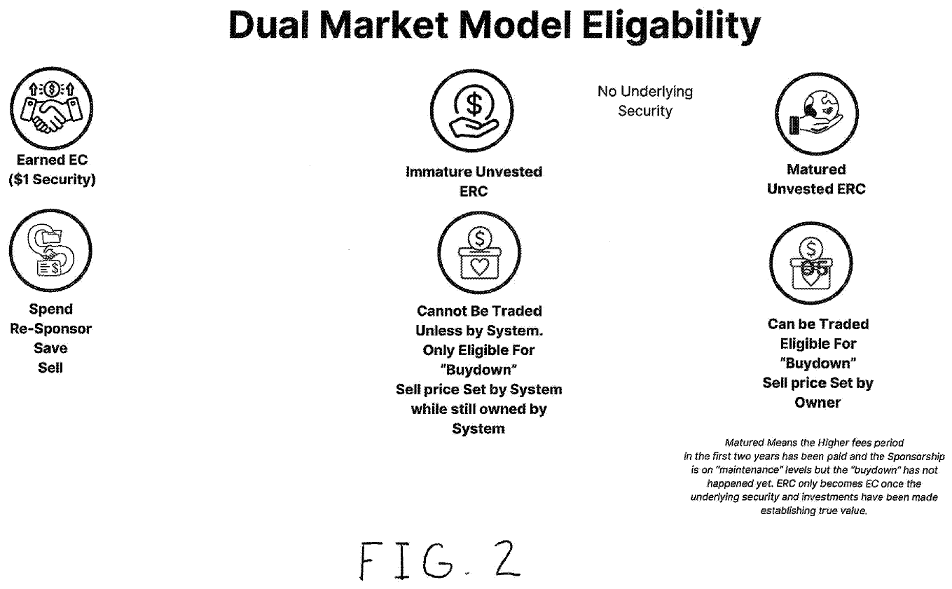

Referring to FIG. 2, once the sponsorship fees are all paid, what was sponsored continues generating power and credits for the sponsor's account for the life of that capacity. It would be possible, for example, for a person to sponsor a certain amount of capacity, set the account to maximize production where everything available is invested directly back into creating new capacity over any immediate gain, and walk away for years as the system continues expanding green capacity, until that person says to start producing. This would result, over time, in that person's sponsorship activity reaching a point where they are more than producing their total power consumption through their sponsorship activity.

If during the life of the active sponsorship payments that minimum threshold is not met when primary payments end, the sponsor takes custody of that ERC and gets to decide when to sell it as long as the minimum value is met. Even if the market price of the ERCs are never met, sponsor contracts will still be bought down, even if the market is not overheating. That is because a sizable portion of the transaction fees of the market exchange and other transactional behaviors are in fact put towards buying down those commitments by the exchange entity itself on a first come first serve basis to encourage individuals re-investing in more green energy capacity to meet the reasonably expanding needs, even if the EC market is not overheating enough to trigger ERCs to be introduced into the market to meet demand. This means that trading volume and other normal fees, minus some other commitments, is what drives green energy demands being met as well.

In a highly simplified model you could say that power being made is what makes EC, trading volume and surge demand go towards creating new capacity to make more EC, creating a positive economic feedback loop in favor of means to create green energy in a way that cannot be easily answered by dirtier means of power production. Rather than looking at a 4, 5-year or more payoff window on new green energy creation capacity, if demand for EC is high enough it can literally take a week if a sudden surge of demand strikes with the ERC component; however, the sponsor knows that the system will pay them back one way or another while producing surplus energy credits. Since the ERCs become sellable as an asset in 2 years at the completion of the contract phase, that becomes an accelerating factor on the ROI of green investment where people who can wait buy those ERCs from those with more immediate need. People in fact would be able to clearly see where the currency needs to be valued in order for new capacity to start multiplying.

If society as a whole decides that EC needs to be valued at the next vesting threshold, which triggers an automatic large expansion of green energy capacity by freeing up potentially billions, or with large-scale adoption, perhaps trillions of dollars in monthly fees to be put towards creating new green energy capacity all over the world as activist investors, institutional investors, and everyday users of currency focus their commerce on the currency that drives green production through their transaction fees and such. This rapid expansion of green energy around the globe would make EVs that much more viable, as there is no longer as much need for oil transportation when people can fill their tank with locally produced green energy purchased with their perhaps locally produced energy credits which are viable currency anywhere in the world.

If Vesting occurs while the sponsorship is being paid off, some or all of the dues paid to date towards a new sponsorship go towards a new sponsorship if they have their account set to automatically carry a new sponsorship as added incentive to do so. This strategy could be used to finance the expansion into green energy for poorer nations where first world coin miners can choose to sponsor capacity in foreign nations. If the EC market accepts the idea, ERCs could also be targeted to have bonuses in certain regions that are in particular need of rapid development.

In cases of very wide differences in currencies such as with the difference between developed and undeveloped nations, sponsors of undeveloped nations can be awarded a certain amount of ERCs each month to normalize the difference between economies. These ERCs may allow them to provide their own cash to convert them now if they would like to take advantage of the current market value or they can wait until they are naturally vested through the buydown process. This class of ERC is also immediately transferable as a non-vested asset as well, allowing people to buy other sponsors out now, hoping to recoup the difference when the asset matures through vesting or other long-term value. The main limitation is that the ERC, while created, must still stay on the servers so they can become vested; if they leave the server, they are removed from line for vesting.

Accounts can be set to “native transactions only” if the owner wants the added security which makes their account unable to interact with anything but the system itself and other optional limitations, such as only being able to transfer to accounts with certain qualities such as ratings, age, country, re-transfer delays, etc. Users would also see where in line all of their associated assets are, along with an estimation based on historical data as to how long they stand until they are likely to be vested.

### 4. Viability in the Global Economy.

Because of the long-term viability of energy as a revenue source, it may render the debate between Capitalism and Communism in a certain regard moot. It does not matter how a person ultimately was awarded the sponsorships-by a government allotted grant, or by purchase through conventional capitalist means with the capitalist government able to assign special tax privileges to the sponsorships (perhaps 15% green energy capital gains tax as well as the estate trusts) that encourages the holding of the assets, which is a more capitalist-friendly way of getting it done by effectively lowering taxes to spur innovation in the economy. Either way, it is a means for their citizens to earn a living as automation expands. Because of the flexibility, it allows both economic models to transition into a green energy economy. After all, both kinds of governments will also receive a share of the EC revenue created automatically as well as their regular tax structure.

With rapid expansion driven by international institutional interests getting involved to fight climate change, it makes it that much sooner that we are able to meet all of our energy needs with green energy, even air traffic. This creation is a tool that can be wielded absent undermining belief in any particular economic model, but ultimately ends up feeding and clothing their citizens in the age of automation, stabilizing their nations for a more peaceful global economy, having both been proven right on how to feed and clothe their people in a sustainable fashion.

What happens to a particular person's ERC if there is a global disaster that destroys several sponsored solar and wind farms? In this case, insurance is covered in the sponsorship and upkeep fees. ERCs are created based on the sponsorship fees, not the asset, and in fact do not necessarily have a specific asset but a small share of pooled infrastructure around the world.

What happens to a particular person's ERC if the person got the ERC only because they let an energy company use their rooftop for solar panels, but their house has now burned down? Are these energy credits fungible and non-specific to a particular source? In this case, a sponsor and a roof owner are not necessarily the same person. The sponsor gets the energy credit from the first dollar and the property owner gets a cut of the sponsorship fees and a smaller stream of EC that comes out of a share of the second dollar accumulated to the creation of an EC.

Finally, price points of the energy credits may be passed on the package. There are normalized pools where all the sponsors get a very small share of the total revenue created across all of them. In this case, if there are 10 sponsors and an 11th is added, they are all putting in the same fixed amount so they get the fixed share regardless of what is doing it. For people that want to act locally or in a more targeted fashion, such as governments or activists, they can sponsor a specific type of infrastructure for us to build in a specific place and type. Basically, if one wants long term steady returns, choose product 1. If the sponsor does not like the idea of any form of nuclear or fusion power generation, for example, or just wants to help X country, the sponsor can sign up for such a sponsorship package. One product may be more investment focused and another is more a development/activism product that will maybe even intentionally give less return because the sponsor knowingly targeted a developing nation with solar sponsorship in a place that cannot yet pay as much for power.

Essentially, the investment question comes down to whether one wants a steady return or instead wants to target how to make a difference even if it reduces the economic gain. A person may have a portfolio of sponsorship assets than if they were a user. For example, one could have 60% General use sponsorships, 30% Oregon energy development (wind and solar by choice), and 10% 3rd-world development. Then, as that energy is created, the investor gets half the revenue to create the EC with the second dollar going to partial EC as designated. Once the ERCs mature, the investor gets paid back for the total cost of their sponsorship in EC. The ERC thus operates as an energy credit future waiting to mature when it is funded by the market-driven buydown process.

### 5. International and Non-Proliferation Advantage of the Green Energy Credit

Because of the centralization of the bulk of EC banking, ECs can be traded on any exchange; only the Official exchange without special relationship, triggers sponsorship buydowns through the unvested reserve ERC thresholds being met, or by transaction fee buydown, meaning that most activity happens through the main system, so it would be feasible to lock it down in specific ways for nations under sanction. This means that the EC governing body could create facilities that create energy for those nations while producing Energy Credits that can be used for humanitarian aid at no additional cost to the American taxpayer. This allows an interested foreign nation the opportunity to begin to normalize their international relations by meeting their power needs through green energy. This allows nations who have traditionally depended on fossil fuels not to be left behind in a green future, creating greater geopolitical stability by establishing EC as a reserve commodity in the financial system.

Furthermore, while some future nuclear technology may end up being green in nature, those would only be on approved nuclear sites controlled with the oversight and monitoring of the EC agency, so it may make development of nuclear programs less appealing as a means of energy production if they would simply be denied eligibility as a means of EC production. This leaves the choice of conventional green energy systems that will pay for themselves in a green grid, or costly governmental programs that will lead to sanctions. While not all would make the better choice, it is our belief that the option could help create new avenues for creating positive geo-political outcomes for the international community.

### EXAMPLE 1

### (One Process of Creating a Hypothetical Energy Credit for a Sponsor)

To use historical analogy, the Medici were able to spur the Renaissance economy through their innovation of double-book accounting to drive their product value based on the better-secured currency created by their unique accounting model of double-book entry. This new system creates a new form of triple-book accounting, that better wholly secures the value of currency based on value created for society, not value consumed from society. The three ledgers are: 1) Conventional currency security in the form of sponsorship commitments, creating the ERC ledger; 2) Conventional currency security underlying the energy-derived crypto currency created by the sale of green energy produced, and; 3) The perpetuation of further green development in the form of revenue generated by fees, buydowns, as well as direct energy credit creation within the system, offsetting environmental and social costs of industry as well as system operating overhead as an added currency value basis.

EC=$1 (base currency security value)

Cost to Create EC=$2

Of each $2 of energy sold:

$1.00 goes to “Sponsor” EC creation

10 cents goes to Government associated with creating the EC (only once $2 vesting level has been reached; half of the credits go to the general fund, half go to sponsorships for citizens who have lost their jobs to automation to help restore their livelihoods, with priority to veterans)

10 cents goes to Source of EC creation

10 cents goes to EC funding scientific research and host nations' education on EC creation

10 cents goes to administrative costs of EC creation

10 cents goes to EC funding carbon capture initiatives and ecological restoration

50 cents Source creator subsidy, land provider subsidy, water subsidy, other unknown costs.

Numbers used are easily divided examples, not final values; values can be altered based on economic necessity.

### EXAMPLE 2

### (EC Creation During Buydown Market)

Once the variable threshold is reached and ERCs can be sold on the market in alternation with ERCs conversion, the creation distribution is modified due to the lack of various parties' allowing the secondary value beyond the base dollar to be sold to cover the total sponsorship costs. If needed, the number of ERC can be increased to a sponsor if it is their turn for buydown but the starting creation ERC are too few at the valuation to cover those costs as initial creation is assumed to be the minimum $2.00:

EC $1.00

Of the second dollar

20% creation costs and overhead

80% goes to paying off sponsorships.

Any surplus market value goes to further paying off sponsorships.

If it is within the first two years before the full security is made, not only is whatever they have paid credited back to them minus maintenance, but because their number came up early, they get to carry over early to get back in line for their next market buydown.

If the bill is paid in energy credit, the credit is split among the interest holders mirroring this mechanic.

This distribution can be adjusted over time, so once the grid switch to green energy has been made, the cost of creation can be reduced accordingly as the needs of the crisis are met and those costs can be reduced as another means of allowing the currency change over the decades as needed.

These are examples of the various functions, all subject to change based on economic forces.

### EXAMPLE 3

### (Potential Breakdown of EC Market Transaction Fee Distribution)

10% exchange cost, of which

5% goes to market security, administration, and other costs.

5% goes to paying off miners' sponsorships.

Ideally the costs could be favoring the miners' sponsorship ERCs as much as possible, maximizing capacity growth.

In other instances, fees may go towards paying off only that account's sponsorships. For example, an EC credit or debit card could channel fees directly to that user's accounts sponsorships, much like a credit card rewards program.

### 6. Pre-Sponsorship Capacity

Capacity is generally built pre-sponsorship so that capacity can be “sponsored” through the website. Once capacity is sponsored, if the ERCs convert while still held by the market, that revenue is immediately spent on new capacity to be put up for sponsorship. If capacity is outstripping adoption, the revenue generated on the surplus is then primarily spent on paying off sponsorships, so people can sponsor the next round while maintaining a surplus for further sponsorship.

This model allows there to be several major revenue sources driving the rapid expansion of green energy production based on the clear and present need for it. If widely adopted, it is our belief that this model could make significant strides in addressing the dire state of the climate crisis. Further, it could lift countless families out of poverty by allowing their investments to have an ongoing return that pays for their own costs of living by proverbially “carrying their own water” from an energy standpoint. This allows the common citizen of the planet to take control of how they source their energy by creating demand for a green-energy-based based crypto currency, and the ability to drive that demand by recognizing value in that currency beyond its base value of underlying currency. That difference between that base value and the market value of this crypto currency is the commoditization of the demand for a green energy future while the ERC NFT allows for the rewarding of its creation as having an innate value to society through free market valuation reaching a specific threshold early.

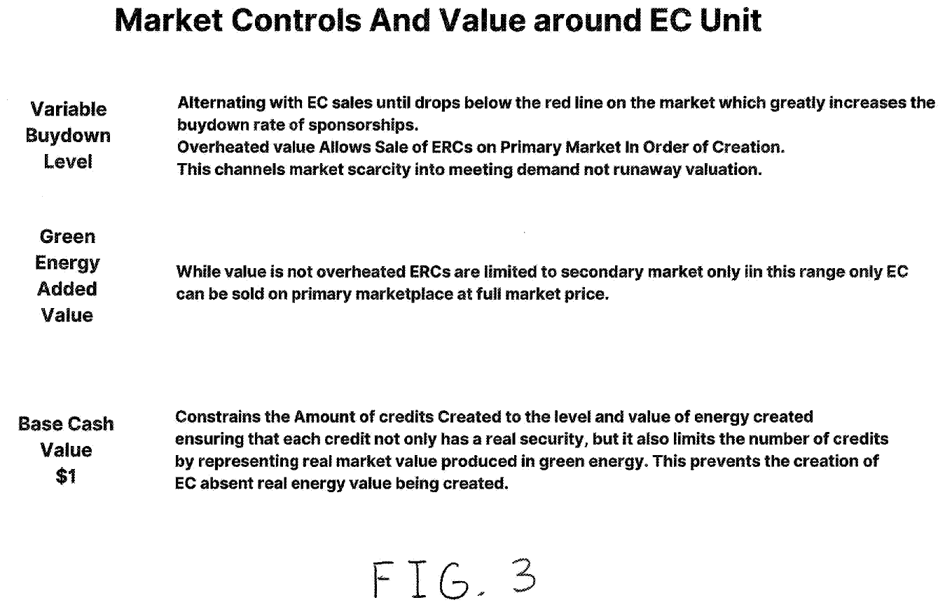

### 7. Variable Buydown Threshold (FIG. 3)

Should the value of a single Energy Credit reach the buydown threshold, instead of all of it going to meet exit demand and feeding excessive valuation on a single credit, the Energy Reserve Credit can be sold by the exchange only once that threshold is reached or exceeded. While normally only fully vested credits are on the exchange, this allows the reserve credit to now be introduced to the exchange until the price drops beneath the threshold again. While that point is met and exceeded, however, ERCs can be sold when the owner's price is met. When that happens, the regular exchange fees apply, with the addition of a “vesting cost”. In order to ensure the exchange does not simply dump endless inventory, denying credit holders all appreciation, only a certain ratio of ERCs can be sold for every EC sold on the exchange at the threshold or higher valuation. So, for example, the exchange or other ERC holder can only sell 1 ERC on the exchange for every 1 full EC sold.

This allows unlimited appreciation to the currency but, at the same time, a proportion of that improved value goes toward building green energy inventory which increases the production of energy credits to meet demand while allowing the sponsors to be rewarded for their creation of energy capacity.

The advantage is that, unlike other commodities where you have to liquidate an asset to get monetary benefit, an investment in the Energy Credit not only helps fight climate change but also can provide a monthly income. Rather than simply paying for electricity with cash that you will never see again, you can put money towards energy credit production and get sustained monthly value to pay your utility with as long as you have sponsored enough panels to generate the needed credits at the current market rate.

This allows a sponsor to effectively pay for going full solar or other green energy piecemeal and affordably, rather than a big contracting project of high cost, and in a way that is not geographically limited to panels being on a roof they may not own, for example.

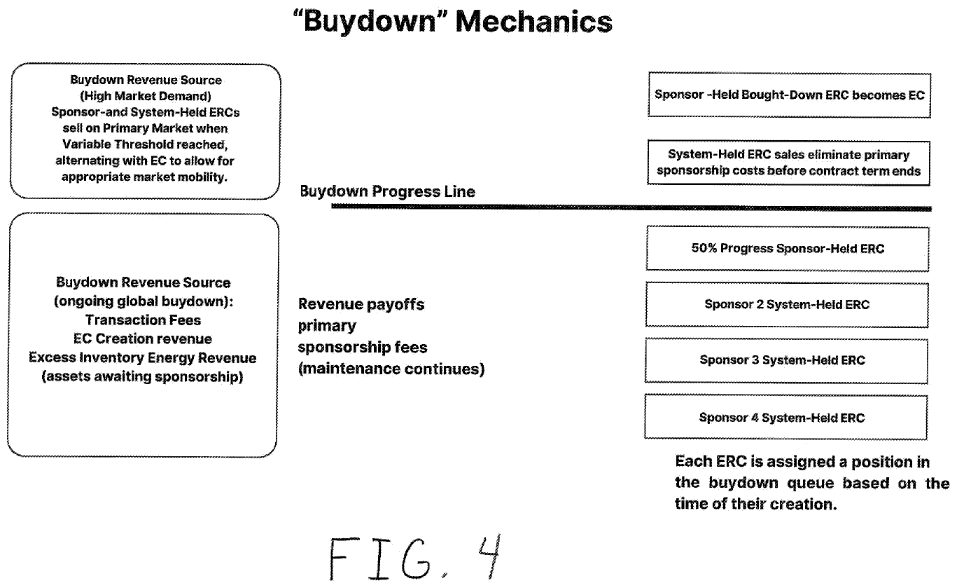

Referring to FIG. 4, the buydown threshold is set based on the scarcity of green energy production. When demand is high the threshold is low, when the demand is low the threshold is high. The threshold is set using either economic oversight, through collective management, or most likely a combination. The “collective management” system is where account owners can use an interface to show where they personally think the threshold should be through their account. This information would be used to inform where the threshold should be placed. This manages the demand on buydown mechanics in a similar way to how the interest rate is used in the global economy. The Secondary Market for ERCs is also a major data point in establishing this basis as well as input from climate scientists on climate progress.

For example, let's say a person wants to go solar, which would be considered a green energy source and therefore qualify. To get a base level Tesla system, it can cost $10,000 with a $1,800 down payment, also assuming that you have a place that can place panels, which eliminates most people who rent. These renters today would have to accept whatever power source they have locally. A green energy crypto currency would remove all of these limitations from the contracting work, cost of entry, and of course the roof issue.

In contrast, an Energy Credit miner can pay, for example, $30 per month on a 2-year commitment, which gives them a set increment of energy production to work for them. Once that time has completed, they continue to get credits from the panel but the operating costs can be taken out of its production, making it a net positive for the sponsor at no further cost to themselves, freeing them to create a new commitment. If in that time, however, they get bought down by the exchange organization, they get relieved of the contract early and re-invest even sooner. If it is not paid off in the duration of the contract, the ERC allotment becomes an asset of the sponsor which they can wait to claim when the market reaches the variable buydown and their sale price or sell on the secondary market for a more immediate return with priority based on their date of creation.

There are sponsor packages that allow you to sponsor a specific amount of a specific type of green energy producing infrastructure. In this case it is talking about a solar panel. These are for people that want to target their development, such as around their communities.

The variable buydown threshold allows some of the runaway valuation caused by scarcity to go towards meeting that need rather than having runaway valuations feeding scarcity and creating volatility, making it a more stable crypto currency derivative as well, while delivering the value back to the people that made the initial investments outside of creating runaway mechanics you find in traditional crypto currencies; rather than excess valuation, they are rewarding with greater capacity to meet the demand for clean energy, which gives that increase in revenue long term. This means all economic forces of reward are working for everyone's needs being met with green energy.

The secondary market for ERCs sales is likely a large indicator on where the variable buydown threshold should be. Likely the more they are worth, the higher the threshold, the less they are worth, the lower the buydown threshold as an individual data point.

In real world application, the ERC buydown threshold would not be very high above the $2.00 value to start out. One of the problems with conventional crypto is the tendency to fluctuate wildly and upward in value. While novel and fun for traders, this makes it a poor choice on which to base an entire economy because if a loaf of bread costs 2 EC when the EC is worth $2.00, that's fine, but if EC were as wildly variable as consumption-based crypto in a week, that single EC is worth $600 because the currency cannot meet demand. This means the economy still has to be based around a less volatile asset because no one wants a $1200 loaf of bread, meaning the price must be set in a conventional currency and then have a conversion or merchants must be hyper vigilant about adjusting their prices, making it useless for certain economic roles that the EC can fill.

Current crypto currencies are today more structured as ongoing Ponzi scheme lotteries where everyone needlessly burns energy so one person, “the winner,” can get all the “value” for all those millions of miners having burned energy for ten minutes. This makes the EC a far more stable and mature form of crypto currency on which to base an international currency, having the value constrained by the security asset at the bottom (the underlying dollar) and the variable buydown threshold at the top of the value, giving it a nice, stable, “not too hot, not too cold” quality you want in a currency. Furthermore, unlike conventional crypto currencies that randomly pick a winner to receive the single coin for the global energy costs, the EC version of crypto currency lines up all the “miners” (in our model we refer them as sponsors since they are not mining for value through random reward based on arbitrary consumption as with traditional miners) to have overheating value directed toward having their underlying assets paid for by the market instead of destabilizing the currency value upward, as is another of the many problems with conventional crypto currencies.

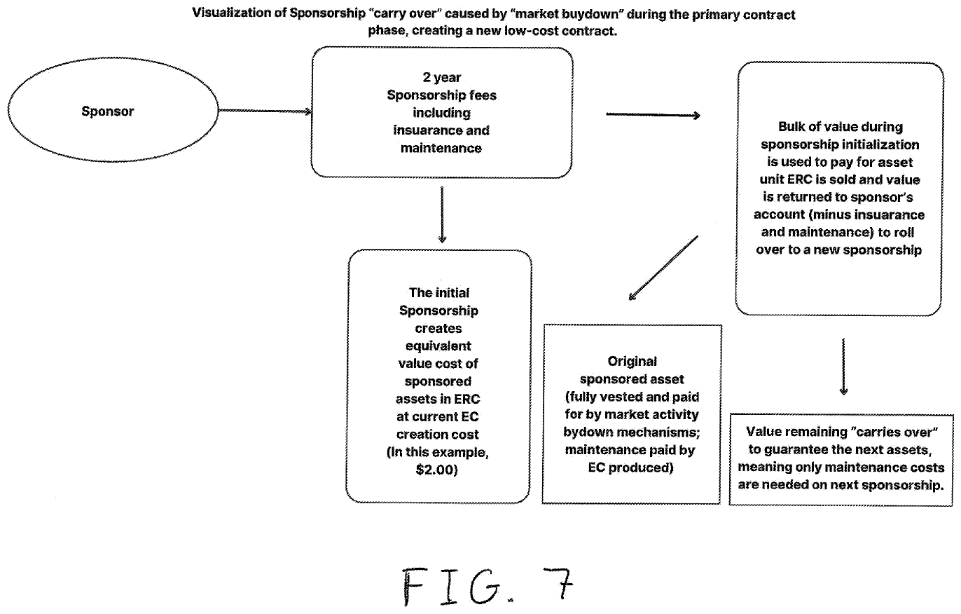

Referring to FIG. 7, and while the EC system does not have the big random win based on arbitrary consumption as traditional crypto, it does have a similar mechanic. Instead of randomly winning “value” (author still argues arbitrary consumption of electricity is the opposite of value but our society disagrees) in the form of a coin, the sponsor, instead of hoping to be the winner someday, knows it is just a matter of time until their sponsorship fees are covered, even if it does not happen immediately. Due to the carryover of non-maintenance costs from the sponsorship, that value can be applied to the next sponsorship to get in line again to be bought down, meaning that next sponsorship still has the previous sponsorship's payments to apply to a new sponsorship as well to wait in line for their next buydown. This means every sponsor knows it is not a matter “if” they get the benefit of the reward, it is a matter of “when,” and until that day happens they have the steady stream of EC heading into their account from sale of the energy produced by their sponsored energy capacity.

### 8. Green Energy Credit as a Reserve Asset.

The Green Energy Credit capacity could be added to government reserves, meaning that governments can use some of their reserves towards fighting climate change without having to sacrifice the value. They could also afford to simply roll the energy credits produced back into more panel sponsorship, meaning that states could turn their grids green by investing in green infrastructure with sponsorships in a lump sum and then just tell the system to fully re-invest in infrastructure. Considering each sponsorship revenue continues well after the main payments are completed for many years, the rights to the produced EC would be a financial asset in and of itself beyond its basic earning potential, meaning that if a state spends $30,000,000 on green energy development, it becomes an immediate asset of greater value than what they put in since that much energy capacity would produce well over its startup cost in energy credits over the life of that capacity (fees go towards indefinite maintenance and repairs including replacement when the time comes, but by that time it is distributed over the remaining life of the panel, meaning a new sponsorship cost is not needed for the replacement). But on day 1, the lifetime of energy production of that asset can be calculated, just like with a conventional energy future in a sense. If the sponsorship is fully paid at once, all of the sponsorships can go into “self-maintenance” where the revenue produced is put towards covering the low maintenance costs before the credits are kept on the account.

States, which are not allowed to print their own currency, could however invest their pensions and such into locally-derived green energy that delivers a regular return in the form of energy credits which themselves are usable as further investment in green infrastructure or put towards pension payout. This could also be applied to the federal social security reserve, essentially paying for the livelihood of retirees by producing and selling green energy for energy credits.

The further possibility of being able to use Federal Social Security funds to both provide the resources to fund social security as well as fight climate change could be an enormous boon to the program and the fight against climate change. This would allow companies that create qualifying energy sources to do large scale infrastructure development with the government where, rather than being the lowest bidder to get the contract, they are literally paying the government for the privilege, since the initial costs of development paid by the government would be far outweighed by the value of the total energy produced for the lifetime of those energy sources.

### 9. As an Energy Company Project

An energy company could use the EC production system to put their panels on other people's property for free without government subsidy. Essentially they share sponsorship with the home owner and both share in the energy credits produced. They can then pay an electric bill with energy credits to offset some or all of their costs. This allows the utility to get power to homes without line loss and pocket the difference in energy credits, while the sponsors cover the cost and get the bulk of the credits.

This process effectively creates a unique energy derivative commodity that can be used as a currency that represents economic production rather than arbitrary consumption in the creation of the crypto currency that is fully backed by not just the value of green energy but of the underlying security as well.

This process also corrects a critical flaw currently confronting capitalism in the age of automation: how an individual human can take part in the economy in the age of automation. Only so many people can actually have the job of fixing the automated machine and it will never be as many people as the machines replaced. By using this model, as automation displaces workers from the workforce, the humans being replaced can get their gainful income from providing the energy that feeds the automation sector and the supply chains feeding humanity. Theoretically, an individual can make their living selling sponsored energy that fuels everything. With everyone equally vested in the value of the green energy credit, it would be valued to a point that could provide livelihoods to their sponsors: entire communities not making a living mining for coal or drilling for oil, but rather monetizing their own power grid going green. A society where everyone carries their own water and energy, you might say. Entire communities can stimulate their economies no matter how remote, or what natural resources they have in the ground, as long as they have square footage and access to the sun or some other green energy sources.

This commoditization of green energy could be used as a backbone of a new economy not based on the consumption of resources and manpower but based on the ability to produce green energy to feed the inevitable automated future. This green energy source exists while providing a livelihood to the people put out of work while feeding that automation's high energy demands. This creates a new positive economic cycle driven by the meeting of our energy needs, allowing humanity to enter an age of literally productive leisure as their sponsorship portfolio, including both self-purchased and inherited energy capacity, meets their living needs by meeting society's power needs. Solar panels can be placed on top of ocean tidal generator facilities where they emerge to take advantage of not only the kinetic energy of the tides below but the unobstructed view of the sky provided by a lack of buildings and trees to block the light.

### 10. National Defense

By using wireless networks, it may be possible to securely make a fully distributed model. This would allow for the formation of an extensive network of micro grids throughout a community. The elimination of dependence on long-range power transmission and moving to more locally produced energy makes areas more resilient to handling natural disasters. This means that not only would the energy credit make it possible to fund green energy based on its free market to reverse climate change, but it also makes humanity more resilient to the effects of climate change. This means that any nation that adopts this standard not only gets to generate a competitive commodity-based currency but also to secure its citizens' energy independence.

Riding this positive economic feedback loop makes it far more likely that humanity will be able to succeed in the fight against climate change profitably in the age of high power demands and automation by creating, not destroying, livelihoods. This moves the economy away from a fully abstract fiat financial system and toward an energy-based commodity system. The new “gold standard” for currency will be a “green energy standard,” tying society's wealth to its ability to produce clean energy for commercial consumption which actually has reproducible value, unlike fossil fuels, showing greater value.

National Defense would be greatly bolstered by this patent's force, given that if this privatized commodity becomes a significant economic force, whatever currency is the underlying security of the Base value effectively becomes the global reserve currency. If a foreign power were to control this process, while early on they may use the greenback as early security to drive adoption, in time they could exchange those reserves for their own currency. This would grant that power the advantage of taking over as the reserve currency and at the same time crashing the value of the American greenback. If America holds this technology, its position of already being the reserve currency makes everything an easy transition for US as well as foreign international interests to the new economy. If a foreign power holds this position, they will get to decide what the global economy looks like and how much that further advantages them, since the very system could even be viewed as a de-facto global sales tax, because owning the majority of the global transaction fees and production distributions will help fund their government, balance budgets and create a green energy net positive society: a potentially massive economic stimulus.

### 11. National Debt

Economically, “print more money” is not a good strategy to settle national debt issues, meaning governments are forced to tax their way out of the problem. The energy credit currency system allows indebted governments to create a real commodity based on meeting an immediate need rather than a currency driven by artificial scarcity. This means that since the value is based on real need met vs abstract value promised, making more is in fact a good thing when not having to account for the concerns of scarcity. By basing currency value on the meeting of a real need vs the collecting of a scarce abstract value, this commodity has a distinct advantage over traditional government fiat currency structures or even currencies that use more conventional commodities such as gold which is arguably more scarcity than need driven in the long term, relatively speaking.

### 12. Veteran Livelihood

Currently programs like the GI Bill invest sizable sums of money into training veterans for the civilian world, for jobs that are often being impacted by stagnant wages and automation. The same resources invested at scale in sponsorships on the veterans' behalf would be able to cover not just educational costs but, once the education is achieved, supplemental income to their employment. Should they lose their job to automation, they would still have their sponsorships to fall back on for retraining or retirement depending on their life stage.

### 13. Currency Security Limited Use

What is allowed with currency reserves of underlying assets is transparent to the market, conservative, and investments consistent with the objectives of the created commodity. For example, here are some of the ways security can be used.

A portion of the security goes towards creating increased inventory for more panels which is then replaced by the energy income until it is sponsored. This further drives green energy investment expansion. This energy in turn does more of the same.

Through bank partnerships, it can be lent out at reduced interest rates for certain classes of greener homes.

Further, it could be used to acquire national debt to bring that debt home, improving the perceived underlying stability of the underlying asset.

This singular derivative creates a single asset to positively impact countless socioeconomic, geo-political, and environmental problems by introducing a new gig to the gig economy for more gainful employment: Green Energy Tycoon. Rather than pouring their money and fuel into burning fossil fuels for their side job, people can build their green energy mining portfolio instead.

What further makes this unique is that this model does not require a federal government involvement as a currency. This derivative structure of re-investment would never likely be able to be created with the treaties necessary to do all of these steps across the geo-political realm. This means that even if a international government ever were to make a similar energy-derived crypto currency, that government would not be able to have the market mechanics that this approach has that creates this currency's greater value over its base security value: driving mass investment into green energy with the sponsorship mechanic, free of need to raise taxes. If governments won't do large-scale investment into green energy, crypto will, and will derive that value accordingly as the only thing greener than cash. If a unique product such as this was invented 10 years ago, how much progress in combating climate change could have been made? If it existed then, would people still be debating how to pay for changes to green energy and how much to invest? This is not a solution in search of a problem, this is an at-least partial solution to the problem of the age: how to make massive investments in green energy, economically and via the free market, not taxation, while also creating livelihoods. While politicians cannot agree that green energy and its production has a intrinsically higher economic and social value than dirty energy to create federal programs, the free market can independently show the inherently higher value of green energy.

In addition, some solar panel sets can have integrated thermometer, barometer, air quality, radiation, and other sensors to be used to improve climate and weather modeling. This can all be integrated along with the financial and energy production data through 5G and satellite networks.

### 14. Estate Planning Product Potential

Because the Federal Government cannot agree on how to tax wealthy estates nor how much to drive green energy investment, they could deem the transfer of energy sponsorships tax-free as part of estates and then use the sponsorships as collateral trusts to allow the revenue to be used over time to amortize the cost of the estate taxes, in an escrow trust that is then released once the estate taxes are paid. These trusts would be set up upon death to represent a certain amount of estate coverage to be paid off in an estimated 10 years. That means once the estate tax has been paid, no matter if it takes 5 years or 20, the rights to those sponsorships transfer directly back to the heirs once the government has been paid. Even if the heirs die in that time period, the taxes still get paid and the new heirs receive the released sponsorships. This means that people might not need to sell off part of their family farm or business to pay the estate tax if they also have green energy income to offset the taxes. Republicans would like a way to reduce estate taxes and Democrats want to fight climate change and encourage green investment, so this derivative seems like a uniquely good vehicle to agree on something. A good investment strategy can render the idea of estate taxes moot and return the green energy asset back into a revenue stream for the heir upon completion, making green energy an investment for every tax bracket.

### 15. ERC to Adjust Collateralization Over Time

Over time it may be necessary, for economic reasons, to gradually or occasionally increase or decrease the amount of underlying collateral. In this case, when the market value is at the level for vestment for sponsorships, some of the buydown ERC revenue also trickles to increasing the underlying commoditization pool for all units, distributed evenly to bolster value according to the forces that determine the ERC market buydown cutoff. When the market cools down, the security can either be allowed to re-dilute or form new credits going forward, at the new level or somewhere in between as governed by market forces.

The current cost to create a single bitcoin is the total mining costs of all active miners producing 1 coin for every 10 minutes. This means that it can cost upward of $10,000 of energy to produce 1 coin that can have a value in excess of $60,000, meaning that our economy is currently rewarding the mere consumption of 72 Terawatts and counting for no other purpose than to do math that does not need doing. It is the belief of the creators of this filing that a real commodity-based, market-driven crypto-derivative design can be more rewarding in smaller increments to the miner through the net positive production of green energy and corresponding value, while creating a more stable currency value not driven by artificial scarcity, but by meeting a real world market demand. Energy credit crypto currency derives its value from its creating new, real value to society, based on the good it does, not based on its needless consumption and its ability to launder money for illicit acts such as human trafficking and extortion.

Specialized solar panels with anti-tamper detection, securely-chipped and network-identified, could even allow for mobile deployment and reporting while producing currency. Sophisticated mapping and analysis systems would be used across the network to identify surplus energy anomalies or other forms of potential tampering compared to what would be expected with the system based on the area. Beyond the accounting practice of registering the currency to match it to an underlying asset in the form of base value, these safeguards would prevent dirty energy's being laundered through a “clean energy” system. With mobile capacity, panels could be used to quickly deploy to open land or to areas in need of disaster recovery, to rebuild utilities in a more robust, distributed form and to be more resilient against future potential disasters. If data is available, light and weather data can also be cross referenced with other resources such as car autopilot sensors as those are features often found with electric cars.

With portability for all contexts fully integrating the systems into the panels themselves, solar panel systems using spare space over freeways and interstates can also have added radar and sensor systems to communicate with and aid self-driving features, potentially making roads safer while serving energy to the local community and producing revenue for the municipality in the form of energy credits, making roads with adequate light an asset to their communities. Some buildings, bridges, and countless other well-lit spaces could become revenue sources for their owners and society.

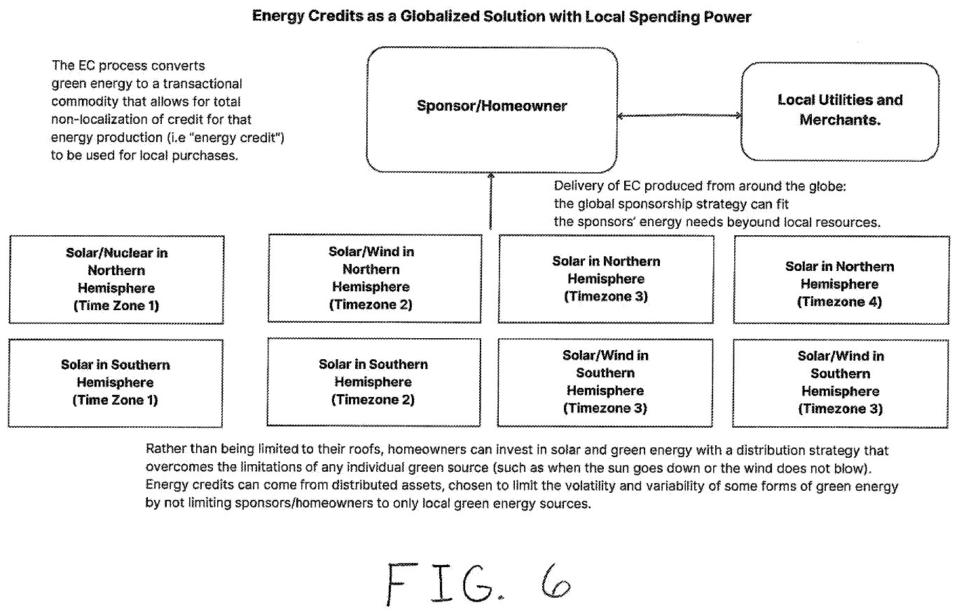

### 16. Flat-rate Power and Credits for Remote Areas (FIG. 6)

Remote areas without a grid to sell to can use a flat charging rate on panels themselves which automatically gets converted to energy credits for the sponsor, using the security features to make sure that ghost energy is not being produced to be wasted simply to make credits until improved infrastructure comes to the area. Far-flung communities can then benefit from the global energy economy with special authorization. This approach could also be rewarded at a different rate, to ensure that the mechanic would only be used in the appropriate context and so that places with little infrastructure can still benefit from smaller-scale green infrastructure, with appropriate subsidization in order to expand the global market's potential green energy development.

Market normalization through even distribution of resulting energy credits across the sponsorships of the whole of inventory could also make differences between structures transparent as an ease of end-user interaction and understanding, eliminating the need to strategize individual markets. This could also lead to different classes of energy sponsorship products for different kinds of sponsors and priorities, such as helping particular developing nations, etc., versus less targeted sponsorship. These would be represented by sponsoring a certain amount of non-specific green energy capacity or sponsorship units versus sponsoring a kind of energy in a specific place like your own community. The added advantage of the globalized approach is that sponsors' interest is distributed around the globe generating power across all timezones and all seasons. This means that seasonal excess or potential energy shortage is mitigated, maximizing the sponsor's solar value through distributed energy credit creation.

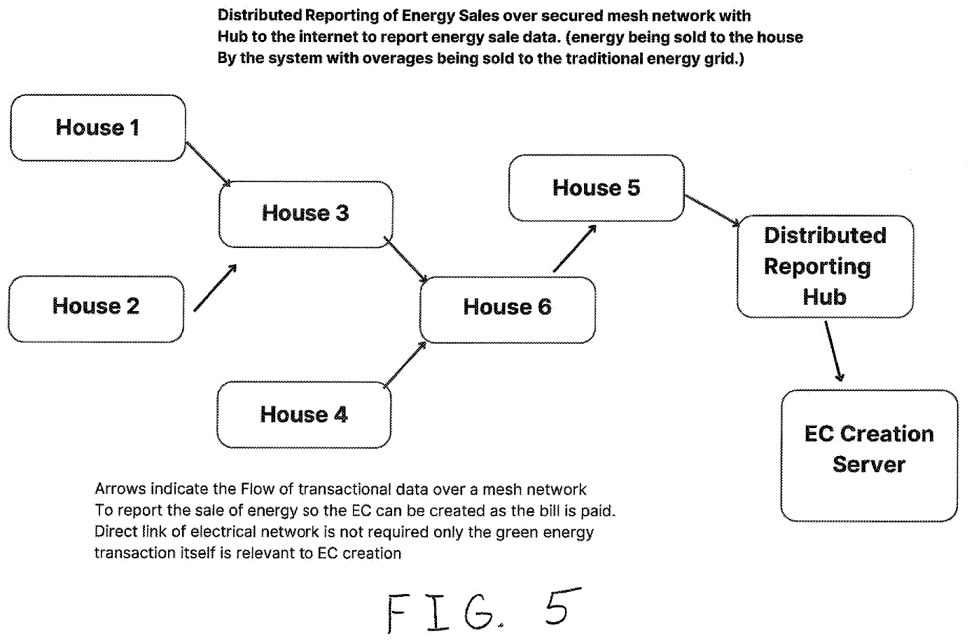

### 17. Individual Portable House Integration of Energy Credit Production (FIGS. 5 and 6)

If fully integrated into a home that includes water processing technology, a portion of the value in the creation base goes towards creating extra energy credits for the homeowner to reward them for meeting some of or all of their water needs without the need of added infrastructure, making them more resilient to natural disasters, reducing their environmental impact and addressing the housing crisis. While being portable enough to go where the work is as well as being mobile for use in natural disasters, the integrated home can function without access to utilities or the need to sacrifice integrated credit production. All this could be made possible by the price drop in photovoltaic technology driven by a potential “gold rush” to the technology, based on consumers' desire to adopt the more reliable return on investment of this green crypto product.

These houses could be integrated with mesh network technology and other resources, economizing the sharing of certain resources in a quick and integrated way. These small mobile houses could be integrated into self-driving systems so homeowners do not need special driving skills or licensing, but instead can simply call the authorized moving service that can utilize people to do the hookups but allow the move itself to be automated until the destination, moving the entire house with minimal packing and not needing infrastructure at the destination-a feature, again, that could be used to great effect to move life-saving resources into natural disaster areas. Water resource demand can be minimized through the creation of automated composting toilet systems and other systems that use more energy and less water and eliminate the need for traditional sewers. These houses can also have “support plans,” much like an “AAA for off-grid tiny houses,” that not only provide affordable maintenance plans but also reward a small amount of energy credits or have a discount if you pay in energy credits.

This could all be made more economical by the likely reduction in cost of solar panels driven by the demand of miner sponsorships and potential buydown mechanics; even short of any rush, the flexibility, portability, and other advantages of solar energy make this the most likely early backbone of this system, likely significantly reducing the cost.

Solar farms could double as land for communities of these houses as both would benefit from similar traits. This means that the rent on the house location, the surplus energy to the grid, as well as the maintenance service would all be affordable services for a lifestyle that uses green energy affordably and at high efficiency. As off-grid technology improves, those houses can be sold locally or even moved overseas as part of a robust refurbished off-grid housing market, allowing nations with fewer resources to adopt the first-world standard of living using the minimum green energy demands of these high-efficiency homes. This could be further driven by a robust leasing market made possible by integrated lockdown systems that also integrate to the greater grid and other resources. Imagine a house-sized, multi-use plug with lock, integrated into the ground at house bays in official developments, making these houses even more affordable while feeding that secondary market as it does for the auto industry.

The rapid expansion of solar and other green energy resources without the need of government subsidies driven by political climates would unlock a whole new level of green expansion, driven by a whole new series of economic tools-tools made possible by this unique derivative process whose rewards transcend politics. These products (lease, support, utilities) could be bundled into affordable packages for multiple budgets and climates while minimizing line loss, having the point of consumption mere feet from production, and minimizing the

### 18. Schools

Schools are often large buildings with large roofs, fields, and playgrounds that could accommodate solar panels through many strategies. Power utilities could partner with schools to take advantage of their tax status to share the benefit of the energy credits beyond the built-in credit share, splitting the sponsorship product between them. This allows these spaces on campuses to be used year-round to produce energy for the surrounding community.

Solar providers like Tesla and their competitors can partner with Scout groups and other non-profits to sell sponsorships as they do cookies or magazines, but for a small amount of residual through sponsorship fee gift cards for new subscriptions, perhaps with some waived or reduced initialization fees. This could allow these companies to supplement their sales strategies while supporting the local communities' interests and expanding into a more personal offer not driven solely by online sign-ups.

### 19. Electric Cars

Car-charging stations could also accept energy credits as well as be energy credit producers. The cost structure could even have discounts for customers paying in energy credits even beyond the exchange rate. Special issue ERCs are possible to subsidize purchases and necessary green research technologies in fuel storage and more. These would be financed by system held infrastructure reserves that perform the proof of work to mature those sponsorships.

### 20. Unique On-Demand NFT Coins for Energy Savings

Not all transactions require a full NFT credit to be created if they are simply being utilized outside the server. In order to protect the privacy of customer holdings, they can keep their credits and personal information off the public Blockchain. This makes the NFT form similar to the equivalent of a cashier check, just as the dual stage of the energy credit NFT system creates similar mechanics to the war bond, only applied to green energy and transactable in and of itself. Additional services could include NFT insurance and creation buttons since the NFT is tied to specific collateral: since the proof of work is all system-side, any theft of the corresponding insured asset would still be retrievable by labeling the NFT as decommissioned on the blockchain along with the revocation of the proof-of-work certification.

### 21. Democratic Governance

A comprehensive democratic governance over dual-stage crypto allows the system to maintain its integrity and protect against corruption.

### 22. Crypto-Integrated Advertising

Advertising can be directly integrated into the market and wallets based on variable CPA structures designed to attract not just customers but specific customer behaviors through transparent and privacy-safe incentives whose revenue can also go towards paying down the ERC inventory.

In the end, there is no freedom without independence and there is no independence without energy independence, whether you are a person or a nation. A product that provides that is necessary if we are to protect democracy going forward in the age of cheap dirty energy protected by special interests stacking the deck in favor of fossil fuels and desperation driven by mass under-employment. By bolstering democracy structurally, it also puts the US back in a position to have its credit rating improved to more democratic levels. Real free market value for a real free market in a way without precedent.

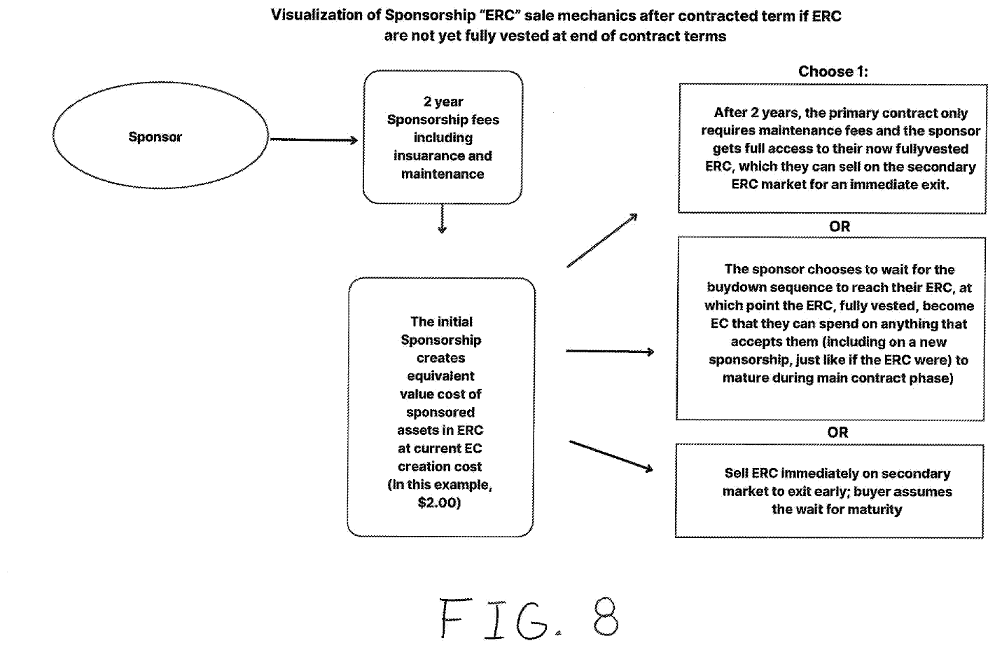

Referring also to FIG. 8, the ERC created when the sponsorship begins helps ensure that it is clear the system in reality covers the initial costs of the infrastructure investment. Since the cost is not in reality borne by the sponsor, that cost becomes added value instead. Since the primary cost is never really felt by the sponsor, that means the “costs” of creating an Energy Credit do not come out of their investment since they only provided the guarantee of the investment but will not bear the actual cost through the ERC market buydown mechanics. This act inverts that creation cost into created value by covering all the creation costs itself, allowing the sponsor to never have to truly pay the costs because the novel market structure of using some of the transaction fees, market volume, surplus inventory, and other related revenue streams to cover the costs of the venture through the ERC system, leaving the EC to be distributed as profit to the sponsors who made the commitment.

The role of the pay-in sponsorship is to be the guarantee allowing the infrastructure suppliers the commitment to cover that infrastructure's costs short term while the ERCs mature to cover the long-term costs at no cost to the sponsor. This public-private sponsorship through additional measures such as estate and other tax cut incentives around sponsorships allows for the unleashing of billions of dollars in green energy funding through free market mechanics, accelerated through potentially the largest tax cuts in history.

If this invention already existed, we would not be fighting climate crises, wildfires, economic insecurity and housing crises with the wringing of our hands at the scope of the disasters that face us. Even now, the American way of free markets, independence and love of country can still be the solution to these global, not just American, problems.

Having described and illustrated the principles of the invention in a preferred embodiment thereof, it should be apparent that the invention can be modified in arrangement and detail without departing from such principles.

What is claimed is:

1. A method for creating and using digital commodity tokens, comprising:
generating dual class energy credits based on the significant net positive production of green energy;
producing Y energy credits for a sponsor for every X amount of green energy sold to the grid;
spending the energy credits as crypto currency, wherein the tokens are characterized as vested tokens, created when a certain amount of energy has been sold that now has an underlying security such as a currency or other secured asset beyond the energy produced, and unvested tokens.

2. The method of claim 1, further including the steps of:
creating a non-fungible token (NFT) such as an Energy Reserve Credit (ERC);
authorizing the sale of ERC tokens only when there is a specific minimum market value on the currency or other specific criteria and context that is tradeable itself so that one is incentivize to reinvest resources into green energy.

3. The method of claim 1, further including the step of specifying for the energy credit a specified minimum value.

4. The method of claim 1, further including the step of putting up and maintaining a certain amount of green energy capacity in exchange for the bulk of the energy credits produced.

5. A method for encouraging continued investment in green energy, comprising:
facilitating sponsorship in a new contract for the creation of new production capacity of green energy;
receiving periodic fees over time for maintenance of the sponsorship;
creating through an exchange an equivalent amount of energy credits to a current total cost of the contract facilitated through sponsorship;
selling the energy credits on an exchange only once an exchange rate for the energy credits reaches a predetermined threshold.

6. The method of claim 5, further including the steps of:
vesting the sponsorship is being paid off; and
paying the period fees toward a new sponsorship.
